(19) United States
(12) Patent Application Publication
(10) Pub. No.: US 2009/0049116 A1
(43) Pub. Date: Feb. 19, 2009

(54) SYSTEM FOR CALLING FOR LOCAL SERVICES OF AT LEAST ONE LOCAL APPLICATION WITH A CONVENTIONAL MESSAGING ARCHITECTURE FROM AT LEAST ONE REMOTE APPLICATION WITH A CONVENTIONAL MESSAGING ARCHITECTURE

(75) Inventors: Francois Ferre, Les Lilas (FR); Jerome Viallet, Antony (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 11/718,231

(22) PCT Filed: Oct. 26, 2005
(86) PCT No.: PCT/EP2005/055563

§ 371 Date: Apr. 27, 2007

(30) Foreign Application Priority Data
Oct. 27, 2004 (FR) 04 11447

(51) Int. Cl. G06F 15/16

(52) U.S. Cl. 709/203; 709/201

(57) ABSTRACT

The present invention relates to a system for calling for local services of at least one local application with a conventional messaging architecture from at least one remote application with a conventional messaging architecture, and it is characterized in that the remote application(s) and local application(s) are provided with communication interfaces using object distributions. According to one embodiment of the invention, said interfaces use the CORBA code.

### CROSS-REFERENCE TO RELATED APPLICATIONS

The present application is based on International Application No. PCT/EP2005/055563 filed on Oct. 26, 2005, which in turn corresponds to France Application No. 04 11447 filed on Oct. 27, 2004, and priority is hereby claimed under 35 USC §119 based on these applications. Each of these applications are hereby incorporated by reference in their entirety into the present application.

### FIELD OF THE INVENTION

The present invention relates to a system for calling for local services of at least one local application with a conventional messaging architecture from at least one remote application with a conventional messaging architecture.

### BACKGROUND OF THE INVENTION

In the present description, which relates to the exchange of commands and data between applications or systems, one of them is arbitrarily termed the client (or remote application) and the others servers (or local applications), without them necessarily being far from one another.

For invoking local services of one application from another, for example with a view to testing a system by a process of stimulation and validation, from a computer, the application and the computer are structured in the form of an n-tiered architecture (n logical layers) one of which is “middleware” (intermediate layer) supporting the CORBA code. Such a solution therefore requires a major modification in the architecture of the application and of the computer. On the other hand, if the local application does not include any middleware supporting the CORBA code, and in particular when it is not possible or not desirable to modify the architecture of this application itself, there is no known solution for invoking local services of the application.

### SUMMARY OF THE INVENTION

One object of the present invention is a system for calling for local services of at least one local application with a conventional messaging architecture from at least one remote application with a conventional messaging architecture which is simple to produce and which does not require any modification to the architecture of the local application nor to that of the remote application.

The system in conformity with the invention is characterized in that the remote application(s) and the local application(s) are provided with communication interfaces using object distributions. According to one embodiment of the invention, these interfaces use the CORBA code.

### BRIEF DESCRIPTION OF THE DRAWINGS

The present invention will be better understood on reading the detailed disclosure of an embodiment given as a non-restrictive example and illustrated by the accompanying drawing in which:

FIG. 1 is a simplified block diagram of a system in conformity with the invention,

FIG. 2 is a simplified diagram illustrating the main steps in generating gateways between a remote application and a local application, in accordance with the inventive method, and

FIG. 3 is a simplified diagram showing details of the different actions performed by the inventive system for establishing communications between a remote application and a local application, in accordance with the inventive method.

### DETAILED DESCRIPTION OF THE INVENTION

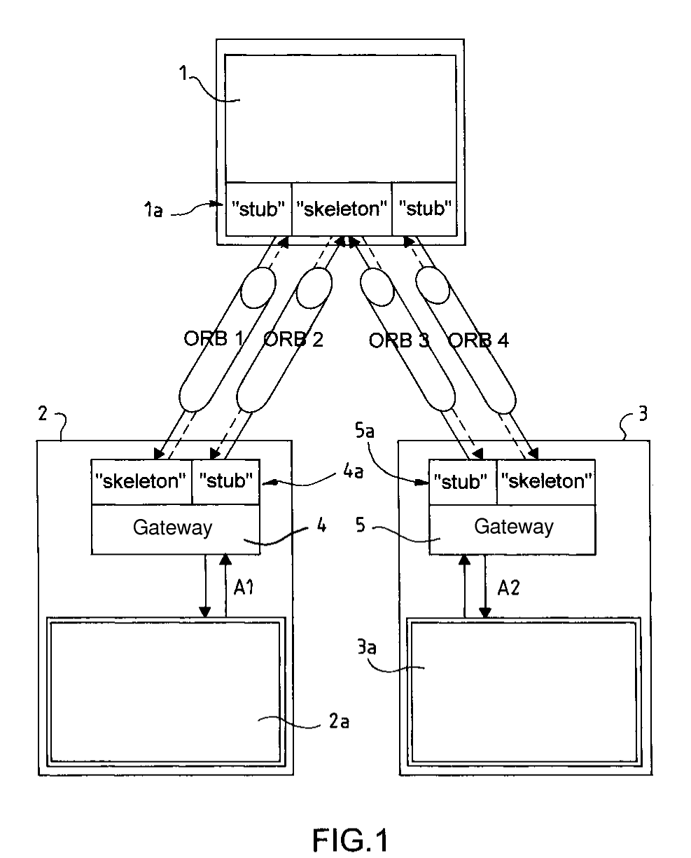

In the simplified example of FIG. 1, a computer 1 or remote application is shown, communicating (simultaneously or not) with two different local applications 2 and 3. For this example, two local applications are shown, but obviously in the inventive system the remote application may communicate with any number of local applications. In the example shown, these two local applications comprise computers 2A, 3A, subjected to validation tests stimulated by application 1, which is a computer validation tool, but obviously the invention is not limited to running tests, and it can be applied to numerous applications requiring exchanges between computers. Applications 2 and 3 each comprise at least one computer, and their computers can implement identical or different processes. For example, the computer in system 2 may implement a process coded in ADA, while the computer in system 3 may implement another process in C++.

According to the invention, each local application is provided with a gateway, 4, 5 respectively. These gateways, here termed “server gateways”, are each provided with a CORBA interface, 4a, 5a respectively, enabling them to interact with an equivalent interface 1a with which the remote application 1 is provided. In a way well known in itself, these interfaces include “stubs” (which are “proxies” converting function calls into messages) and “skeletons” (which are adapters inversely converting messages into function calls). These interfaces are suitable for generating a communication code which in the present instance is the CORBA code. Thus, this CORBA code acts as a “transparent” means of communication between the test computer 1 and the local applications 2 and 3 undergoing tests. Said code is carried by a CORBA bus 100, through which the distributed objects therefore pass. These objects are represented by the symbols ORB1, ORB2 and ORB3, ORB4. Said objects (or kernels) are message transport vectors for transmitting CORBA calls performed between the remote application 1 and the local applications 2 and 3, respectively. On the other hand, calls A1 and A2 passing in both directions, between the gateways 4 and 5 and the computers 2A and 3A respectively, are local calls, which are not, it is assumed, in CORBA code.

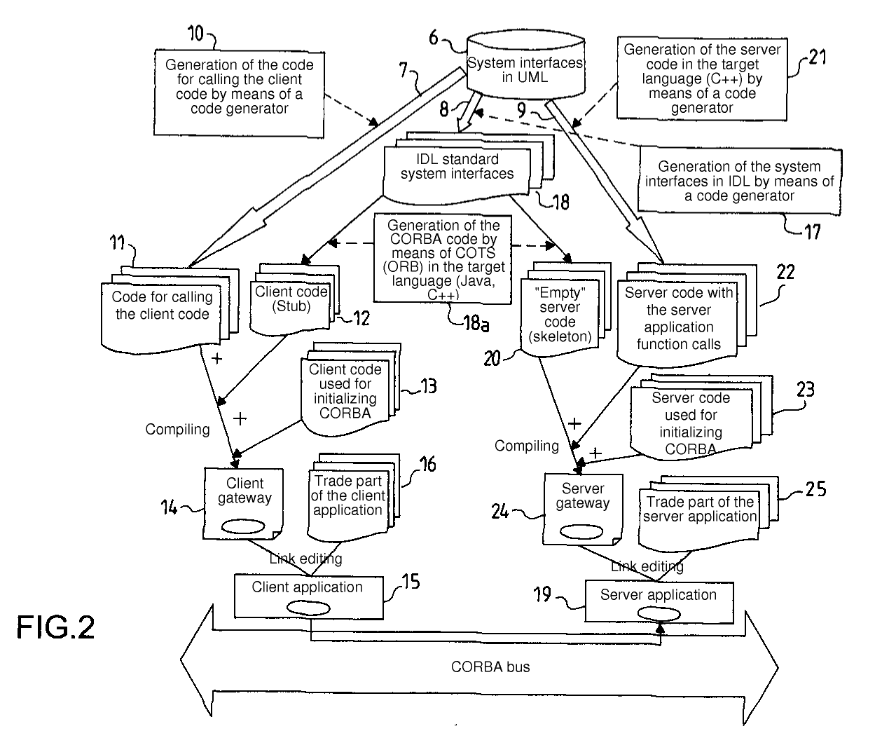

With reference to FIG. 2, the various steps will be explained that are necessary for generating a gateway according to the invention. Starting with a model of an interface 6 of a system subjected to tests, e.g. system 2, said model being in the UML language in the present instance, it is installed in the remote application, which takes on the function of a client application. This model is associated with a generator which generates the IDL code referenced 8 (Interface Description Language), supported by the CORBA code. Generating the implementation of the previously generated interfaces in the target language of the local application is carried out via ‘client’ and ‘server’ generators in two main steps referenced 7 and 9.

In step 7, the ‘client’ generator first of all initiates the generation (10) of a code for calling the client code. This code (11), overwrites the client code 12 (relative to the “stub” of the client application and generated in step 18a, as disclosed below), then via another client code (13) which is used for initializing the CORBA mechanism, and compiled with them, produces the client gateway 14 (such as the gateway 1a in FIG. 1). This gateway 14 is then connected via a link editor of the client application 15 to the “trade” part 16 of this application, in order to create the executable client.

In step 8, the IDL generator generates (17) the interfaces (18) of all the client and server applications. These interfaces 18 generate (18a) CORBA code, preferably by means of CORBA dedicated commercial (COTS) “middleware”, in the target language (that of the application intended to receive this code, and which can be Java, C++, etc.). First, the interfaces 18 generate the abovementioned client code 12, and secondly, they generate a server code 20, which is the “skeleton” of the server application 19.

In step 9, the ‘server’ generator generates (21) a server code (22) in the target language of the application 19. This code 22, comprising the function calls of the application 19, overwrites the code 20, and is completed by a server code 23 (used for initializing the CORBA process). This is all compiled to produce the server gateway 24. This gateway 24 is then connected via a link editor of the server application 19 to the “trade” part 25 of this application, in order to create the executable server.

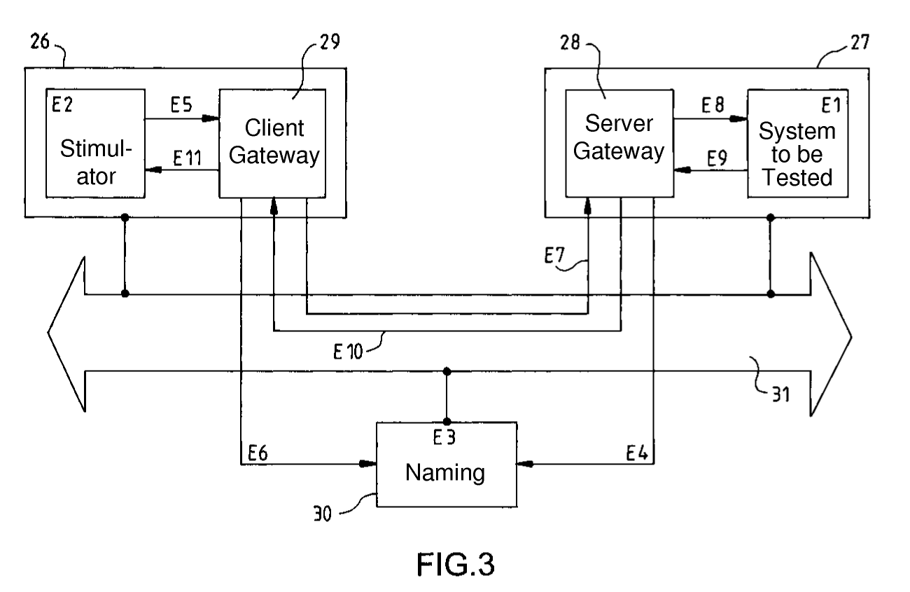

In the diagram in FIG. 3, the various successive steps are shown for setting up the necessary means for communications between a remote application (or client, which is, in the present instance, a test system) 26 and a local application 27 (or server, which is, in the present instance, the system to be tested), and in particular the formation of the server gateway 28. These various steps are as follows:
E1: activation of the system 27 to be tested.
E2: start-up of the test system, which starts up the client gateway 29.
E3: start-up of the “naming service” 30 of the CORBA code carried by the CORBA bus 31.
E4: registering the server gateway in the naming service.
E5: the remote application invokes a first service that has to be performed by the server.
E6: the client gateway 29 interrogates the naming services.
E7: the CORBA services marshal the data corresponding to the service invoked, convey the invocation thus marshaled, decode these data, and invoke the actual object corresponding to this service in the server gateway 28.
E8: the server gateway 28 calls up the function relating to the invoked service, in the tested system 27.
E9: the tested system 27 sends back the response to the service invocation that it has just received.
E10: the CORBA services marshal the data, convey the invocation thus marshaled to the client, decode the data and transmit them to the client gateway 29.
E11: the gateway 29 transmits the invocation to the application 28 by calling up the real code in this application.

1. A system of calling for local services of at least one local application with a conventional messaging architecture from at least one remote application with a conventional messaging architecture, wherein the remote application(s) and local application(s) include communication interfaces using object distributions.

2. The system as claimed in claim 1 wherein the interfaces use CORBA code.

3. The system as claimed in claim 1, wherein the interfaces are generated by an IDL generator.

4. The system as claimed in claim 2, wherein the interfaces are generated by an IDL generator.

5. A system for requesting client services of a client application using messaging architecture from a server application using a messaging architecture, comprising:
server gateway means for communicating with client gateway means using object distributions.

6. The system as claimed in claim 5, wherein the server gateway means and the client gateway means use CORBA code.

7. The system as claimed in claim 5, wherein the server gateway means and the client gateway means are generated by an IDL generator.

8. The system as claimed in claim 6, wherein the server gateway means and the client gateway means are generated by an IDL generator.
